(19) United States
(12) Patent Application Publication
(10) Pub. No.: US 2008/0090558 A1
(43) Pub. Date: Apr. 17, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,469

(22) Filed: Sep. 21, 2007

(30) Foreign Application Priority Data
Sep. 28, 2006 (JP) 2006-264750

(51) Int. Cl. H04M 1/727

(52) U.S. Cl. 455/414.2

(57) ABSTRACT

A mobile device system and a communication device which can flexibly respond to the living environment to prevent misplacement are provided. In each mobile device, outside a specified area which is registered in advance, when a combination of other mobile devices detected as being located within a predetermined range of that device does not match a combination of other mobile devices registered in a group registration unit, misplacement of a mobile device is announced by operating an announcing unit. Inside the specified area on the other hand, even if the combination of other mobile devices detected as being located within the predetermined range of that device does not match the combination of other mobile devices registered in the group registration unit, the announcing unit is not operated.

### BACKGROUND OF THE INVENTION

1. Field of the Invention

The present invention relates to a mobile communication system and a mobile device which can quickly announce misplacement or the like of a mobile device.

This application is based on Japanese Patent Application No. 2006-264750, the content of which is incorporated herein by reference.

2. Description of Related Art

Recently, due to the diversification of information, when people go out, in many cases they carry multiple mobile devices having various functions, such as mobile phones, laptop computers, information communication terminals, digital cameras, and music players (see Japanese Unexamined Patent Application, Publication No. 2002-9879).

Along with this trend, a technology for preventing users from forgetting to take their mobile device when going out and misplacing it outside the home has been proposed (see Japanese Unexamined Patent Application, Publication No. 2006-60544).

For example, Japanese Unexamined Patent Application, Publication No. 2006-60544 discloses a technology for periodically sending and receiving location information between a wireless key and a communication phone terminal, determining the distance therebetween on the basis of this information, and providing an alert about forgetting to take it or the like when this distance becomes greater than a predetermined distance.

### BRIEF SUMMARY OF THE INVENTION

A first aspect is a mobile device system including a plurality of mobile devices, wherein each mobile device includes a device detection unit for periodically detecting other mobile devices located within a predetermined range of that device, a group registration unit in which at least one of the other mobile devices is registered as a group, an announcing unit, and a control unit, when a group status of the other mobile devices detected by the device detection unit differs from a group status registered in the group registration unit, the control unit operates the announcing unit, each mobile device includes a specified-area detection unit for detecting that the mobile device is inside a specified area, and when it is detected that the mobile device is in the specified area by the specified-area detection unit, the control unit stops operating the announcing unit.

A second aspect is a mobile device system including a plurality of mobile devices; wherein each mobile device includes a device detection unit for periodically detecting other mobile devices located within a predetermined range of that device, a group registration unit in which at least one of the other mobile device is registered as a group, a function-restricting unit for restricting a predetermined function, and a control unit, wherein when a group status of the other mobile devices detected by the device detection unit differs from a group status registered in the group registration unit, the control unit operates the function-restricting unit; each mobile device includes a specified-area detection unit for detecting whether the mobile device is inside a specified area; and when it is detected by the specified-area detecting unit that the mobile device is in the specified area, the control unit stops operating the function-restricting unit.

A third aspect is a mobile device including a device detection unit for periodically detecting other mobile devices located within a predetermined range of that device, a group registration unit in which at least one of the other mobile devices is registered as a group, an announcing unit, and a control unit, wherein when a group status of the other mobile devices detected by the device detection unit differs from a group status registered in the group registration unit, the control unit operates the announcing unit, wherein the mobile device includes a specified-area detecting unit for detecting that the mobile device is in the specified area; wherein when it is detected by the specified-area detecting unit that the mobile device is in the specified area, the control unit stops operating the announcing unit.

A fourth aspect is a mobile device including a device detection unit for periodically detecting other mobile devices located within a predetermined range of that device, a group registration unit for registering at least one of the other mobile devices as a group, a function-restricting unit for restricting a predetermined function, and a control unit, wherein when a group status of the other mobile devices detected by the device detection unit differs from a group status registered in the group registration unit, the control unit operates the function-restricting unit, wherein the mobile device includes a specified-area detecting unit for detecting that the mobile device is in the specified area; wherein when it is detected by the specified-area detecting unit that the mobile device is in the specified area, the control unit stops operating the function-restricting unit.

### BRIEF DESCRIPTION OF THE SEVERAL VIEWS OF THE DRAWINGS

FIG. 1 is a diagram showing the configuration of a mobile device system according to a first embodiment.

FIG. 2 is a diagram showing common components provided in each mobile device in the mobile device system according to the first embodiment.

FIG. 3 is a diagram showing an example of information stored in a storage unit of a mobile phone according to the first embodiment.

FIG. 4 is a flowchart showing the procedure of a misplacement detection process executed by a control unit according to the first embodiment.

FIG. 5 is a diagram showing a display example in a case where a PDA and a computer are located in the vicinity of the mobile phone.

FIG. 6 is a diagram showing common components provided in each mobile device in a mobile device system according to a second embodiment.

### DETAILED DESCRIPTION OF THE INVENTION

A mobile device system of the present invention includes a plurality of mobile devices, wherein each mobile device includes a device detection unit for periodically detecting other mobile devices located within a predetermined range of that device, a group registration unit in which at least one of the other mobile devices is registered as a group, an announcing unit, and a control unit; when a group status of the other mobile devices detected by the device detection unit differs from a group status registered in the group registration unit, the control unit operates the announcing unit, each mobile device includes a specified-area detection unit for detecting that the mobile device is inside a specified area, and when it is detected that the mobile device is in the specified area by the specified-area detection unit, the control unit stops operating the announcing unit.

With this configuration, the other mobile devices located within the predetermined range of a particular device are periodically detected by the device detection unit provided in each mobile device, and it is determined, by the control unit, whether or not the combination of detected other mobile devices matches the combination of other mobile devices registered in the group registration unit. If, as a result, the two do not match, the announcing unit is operated, and therefore, the user can notice the misplacement based on this announcement. On the other hand, in the specified area, even when the combination of mobile devices detected by the device detection unit does not match the combination of other mobile devices registered in the group registration unit, the announcing unit is not operated. Therefore, for example, by registering as the specified area a place where, of the plurality of mobile devices registered as a group, only some of the mobile devices are temporarily taken outside and used, the user is not bothered by an announcement in such places.

The above phrase “when a group status of the other mobile devices detected by the device detection unit differs from a group status registered in the group registration unit” means, for example, when the combination of other mobile devices detected by the device detection unit differs from the combination of mobile devices registered in the group registration unit, or, when the number of other mobile devices detected by the device detection unit differs from the number of other mobile devices registered in the group registration unit.

Another mobile device system of the present invention includes a plurality of mobile devices; wherein each mobile device includes a device detection unit for periodically detecting other mobile devices located within a predetermined range of that device, a group registration unit in which at least one of the other mobile device is registered as a group, a function-restricting unit for restricting a predetermined function, and a control unit, wherein when a group status of the other mobile devices detected by the device detection unit differs from a group status registered in the group registration unit, the control unit operates the function-restricting unit; each mobile device includes a specified-area detection unit for detecting whether the mobile device is inside a specified area; and when it is detected by the specified-area detecting unit that the mobile device is in the specified area, the control unit stops operating the function-restricting unit.

With this configuration, the other mobile devices located within the predetermined range of a particular device are periodically detected by the device detection unit provided in each mobile device, and it is determined, by the control unit, whether or not the combination of detected other mobile devices matches the combination of other mobile devices registered in the group registration unit. If, as a result, the two do not match, the function-restricting unit is operated; therefore, it is possible to prevent the misplaced mobile device from being used by someone else, and by making it impossible to use the predetermined function of the mobile devices being carried, the user can notice the misplacement.

On the other hand, in the specified area, even when the combination of mobile devices detected by the device detection unit does not match the combination of other mobile devices registered in the group registration unit, the function-restricting unit is not operated. Therefore, for example, by registering as the specified area a place where, of the plurality of mobile devices registered as a group, only some of the mobile devices are temporarily taken outside and used, function restriction, which is not required in such places, can be eliminated, and the user can use each mobile device in the same manner as usual.

The above phrase “when a group status of the other mobile devices detected by the device detection unit differs from a group status registered in the group registration unit” means, for example, when the combination of other mobile devices detected by the device detection unit differs from the combination of mobile devices registered in the group registration unit, or, when the number of other mobile devices detected by the device detection unit differs from the number of other mobile devices registered in the group registration unit.

In the mobile device systems described above, each mobile device may include a location-information acquisition unit for acquiring location information; and when the location information acquired by the location-information acquisition unit belongs to the specified area which is registered in advance, the specified-area detection unit may detect that the mobile device is inside the specified area.

With this configuration, because each mobile device includes the location-information acquisition unit, the specified-area detection unit can easily detect that the mobile device is inside the specified area by determining whether or not this location information belongs to the specified area registered in advance.

In the mobile device systems described above each mobile device may include a communication unit; and when identification information of a server which communicates with the communication unit matches identification information registered in advance, the specified-area detection unit may detect that the mobile device is inside the specified area.

With this configuration, because each mobile device includes the communication unit, the specified-area detection unit can easily detect that the mobile device is inside the specified area by determining whether or not the identification information of the server with which a circuit is established with this communication unit matches the identification information that is registered in advance.

In the mobile device systems described above, each mobile device may include an input unit for the user to register the specified area.

With this configuration, because each mobile device includes the input unit for registering the specified area, the user can register the specified area by himself or herself.

In the mobile device systems described above, each mobile device may include a registration-cancellation-area detection unit for detecting whether or not the mobile device is in a registration cancellation area; and when it is detected by the registration-cancellation-area detection unit that the mobile device is in the registration cancellation area, the control unit may cancel group registration in the group registration unit, and when it is detected by the registration-cancellation-area detection unit that the mobile device is outside the registration cancellation area, the control unit may register the other mobile devices detected by the device detection unit as a group in the group registration unit.

With this configuration, when it is detected by the registration-cancellation-area detection unit provided in each mobile device that the mobile device is in the registration cancellation area, group registration in the group registration unit is cancelled, and when leaving this registration cancellation area, the other mobile devices which are carried together at that time are registered as a new group in the group registration unit. Therefore, for example, by registering one's home as the registration cancellation area, it is possible to stop the announcing and function-restricting operations at home, and when going outside, it is possible to always register the combination of mobile devices taken out of the home as a group. Thus, even if the mobile devices that are carried differ from day to day, the system can respond accordingly and can always perform proper group registration of the mobile devices.

In the mobile device systems described above, each mobile device may include a location-information acquisition unit for acquiring location information of that device and a communication unit for performing communication with other mobile devices; and when the location information acquired by the location-information acquisition unit is sent to the other mobile devices using the communication unit and when location information is received from the other mobile devices by the communication unit, the device detection unit may detect the other mobile devices that are located within the predetermined range of that device on the basis of that location information and the location information of that device.

With this configuration, the location information acquired by the location-information acquisition unit of each mobile device is periodically sent to the other mobile devices by operating the communication unit. Accordingly, the location information of each mobile device is mutually sent and received between the mobile devices. Thus, because the device detection unit of each mobile device can acquire the location information of the other mobile devices, it can detect the other mobile devices located within the predetermined range of that device on the basis of this location information and the location information of that device.

In the mobile device systems described above, each mobile device may include a short-range communication unit for communicating with other mobile devices; and identification information assigned to that device may be sent using the short-range communication unit, and the detection unit may detect the other mobile devices that are located within the predetermined range of that device based on whether or not identification information is received from the other mobile devices by the short-range communication unit.

With this configuration, because the short-range communication unit of each mobile device sends the identification information assigned to that device, this identification information is received by the other mobile devices located within the communication range of the short-range communication unit. The device detection unit of each mobile device can easily detect the other mobile devices located within the predetermined range of that device by determining whether or not the identification information could be received.

A mobile device of the present invention includes a device detection unit for periodically detecting other mobile devices located within a predetermined range of that device, a group registration unit in which at least one of the other mobile devices is registered as a group, an announcing unit, and a control unit, wherein when a group status of the other mobile devices detected by the device detection unit differs from a group status registered in the group registration unit, the control unit operates the announcing unit, wherein the mobile device includes a specified-area detecting unit for detecting that the mobile device is in a specified area; wherein when it is detected by the specified-area detecting unit that the mobile device is in the specified area, the control unit stops operating the announcing unit.

With this configuration, the other mobile devices located within the predetermined range of a particular device are periodically detected by the device detection unit, and it is determined, by the control unit, whether or not the combination of detected other mobile devices matches the combination of other mobile devices registered in the group registration unit. If, as a result, the two do not match, the announcing unit is operated, and therefore, the user can notice misplacement based on this announcement. On the other hand, in the specified area, even when the combination of mobile devices detected by the device detection unit does not match the combination of other mobile devices registered in the group registration unit, the announcing unit is not operated. Therefore, for example, by registering as the specified area a place where, of the plurality of mobile devices registered as a group, only some of the mobile devices are temporarily taken outside and used, an unnecessary announcement can be eliminated in such places.

The above phrase “when a group status of the other mobile devices detected by the device detection unit differs from a group status registered in the group registration unit” means, for example, when the combination of other mobile devices detected by the device detection unit differs from the combination of mobile devices registered in the group registration unit, or, when the number of other mobile devices detected by the device detection unit differs from the number of other mobile devices registered in the group registration unit.

Another mobile device of the present invention includes a device detection unit for periodically detecting other mobile devices located within a predetermined range of that device, a group registration unit for registering at least one of the other mobile devices as a group, a function-restricting unit for restricting a predetermined function, and a control unit, wherein when a group status of the other mobile devices detected by the device detection unit differs from a group status registered in the group registration unit, the control unit operates the function-restricting unit, wherein the mobile device includes a specified-area detecting unit for detecting that the mobile device is in a specified area; wherein when it is detected by the specified-area detecting unit that the mobile device is in the specified area, the control unit stops operating the function-restricting unit.

With this configuration, the other mobile devices located within the predetermined range of a particular device are periodically detected by the device detection unit, and it is determined, by the control unit, whether or not the combination of detected other mobile devices matches the combination of other mobile devices registered in the group registration unit. If, as a result, the two do not match, the function-restricting unit is operated; therefore, it is possible to prevent the misplaced mobile device from being used by someone else, and by making it impossible to use the predetermined function of the mobile devices being carried, the user can notice the misplacement. On the other hand, in the specified area, even when the combination of mobile devices detected by the device detection unit does not match the combination of other mobile devices registered in the group registration unit, the announcing unit is not operated. Therefore, for example, by registering as the specified area a place where, of the plurality of mobile devices registered as a group, only some of the mobile devices are temporarily taken outside and used, function restriction, which is not required in such places, can be eliminated, and the user can use each mobile device in the same manner as usual.

The above phrase “when a group status of the other mobile devices detected by the device detection unit differs from a group status registered in the group registration unit” means, for example, when the combination of other mobile devices detected by the device detection unit differs from the combination of mobile devices registered in the group registration unit, or, when the number of other mobile devices detected by the device detection unit differs from the number of other mobile devices registered in the group registration unit.

The various aspects described above can be used in combination within the permissible scope of the invention.

The mobile device system or mobile device described above can flexibly respond to the living environment, which affords an advantage in that it is possible to prevent misplacement or the like.

Embodiments of a mobile device system will be described below with reference to the drawings.

### FIRST EMBODIMENT

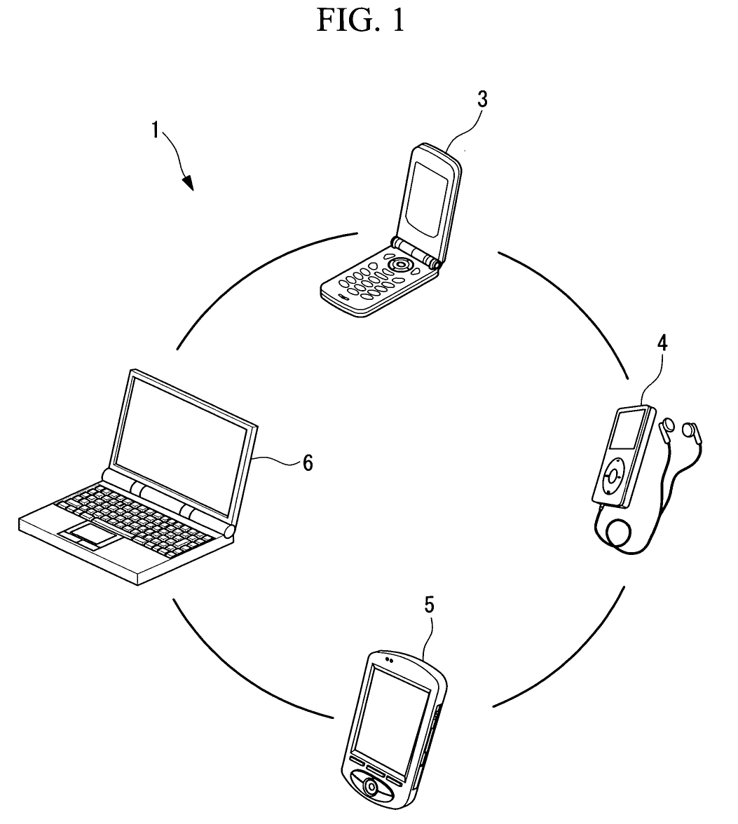

FIG. 1 illustrates an example configuration of a mobile device system 1 according to a first embodiment. As shown in the drawing, the mobile device system 1 includes a plurality of mobile devices, more specifically, a mobile phone 3, a portable music player 4, a PDA (personal digital assistant) 5, and a laptop computer (hereinafter referred to as ‘computer’) 6. These mobile devices are only examples, and in general, any type of portable electronic device may be used in any combination.

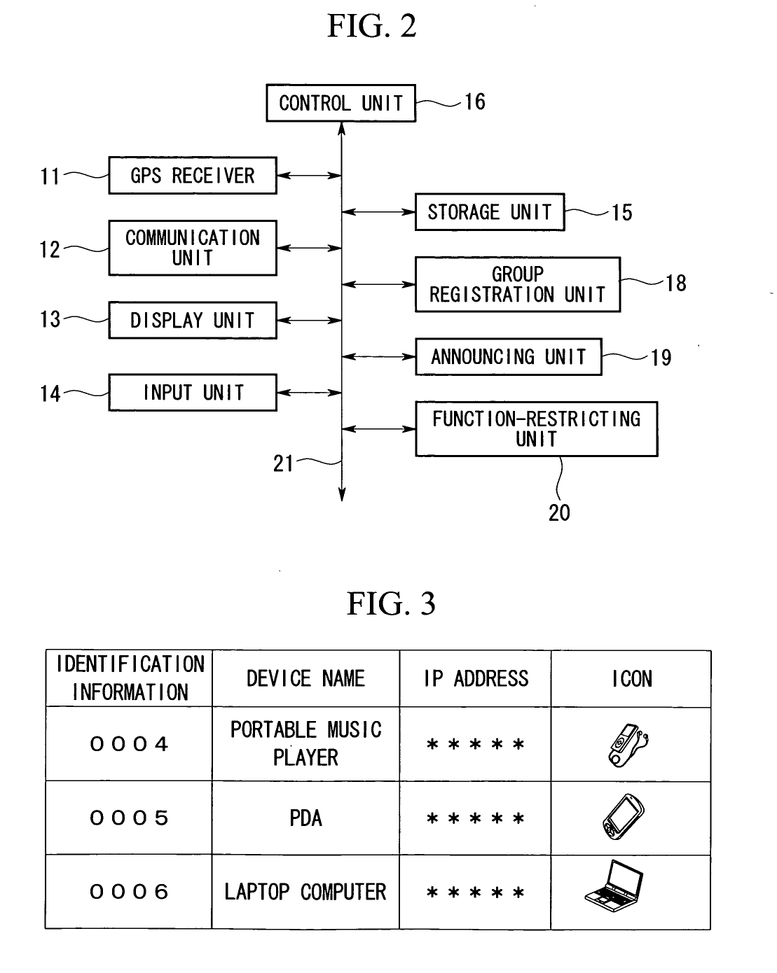

Each of the above-described mobile devices includes the following common components. Specifically, as illustrated in FIG. 2, each mobile device includes a GPS receiver (location-information acquiring device) 11, a communication unit (communication device) 12, a display unit 13, an input unit (input device) 14, a storage unit 15, a control unit (control device) 16, a group registration unit (group registration device) 18, an announcing unit (announcing device) 19, and a function-restricting unit (function-restricting device) 20. These units are mutually connected via a bus 21 and are configured to be capable of sending and receiving information between each other.

The components described above may be provided separately from components that are generally included in each mobile device, or they may also be used in conjunction with the components generally included in each mobile device. For example, since the mobile phone 3 generally includes a communication unit, a display unit, and an input unit, these components are preferably used in conjunction. This also applies to the other mobile devices.

The GPS receiver 11 periodically receives a signal from a GPS satellite, acquires location information of that device on the basis of the received signal, and outputs the location information to the control unit 16.

The communication unit 12 is capable of communicating with other mobile devices wirelessly. For example, the communication unit 12 of the mobile phone 3 is capable of communicating with the music player 4, the PDA 5, and the computer 6.

The display unit 13 is, for example, a liquid crystal display. The input unit 14 is, for example, a keyboard or buttons and functions as a man-machine interface.

The storage unit 15 holds information about the other mobile devices, location information of a specified area, location information of a registration-cancellation area, and so forth.

Identification information of each of the other mobile devices is stored as the above-mentioned information about the other mobile devices, and various kinds of information, including the device name, information for enabling two-way communication, and image data to be displayed on the display unit 13, are linked to each item of identification information. The information for enabling two-way communication is, for example, an IP address of the other party. The image data to be displayed on the display unit 13 is, for example, icons or text information. For example, as shown in FIG. 3, identification information of the portable music player 4, the PDA 5, and the computer 6 is stored in the storage unit 15 of the mobile phone 3 as information about the other mobile devices. The device names, IP addresses, and image data to be displayed on the display unit 13 are linked to each item of identification information and stored.

The control unit 16 performs overall control of the above-described units. In addition, as described later, it includes a device detection function (device detection apparatus), a specified-area detection function (specified-area detection apparatus), and a registration-cancellation-area detection function (registration-cancellation-area detection apparatus).

Identification information of the other mobile devices located within a predetermined range of the mobile device is registered in the group registration unit 18.

The announcing unit 19 is a device for announcing misplacement to the user. For example, it is possible to employ an illumination unit that performs announcement by means of being illuminated, such as an LED, an audio output unit that provides an audible announcement, such as a speaker, or a vibration unit that performs announcement by means of vibrations, such as a vibrator.

The function restricting unit 20 restricts a predetermined function possessed by the mobile device when the combination of other mobile devices located within the predetermined range changes. Examples of the predetermined function include a receiving function, a transmitting function, a display function, a playback function, a data reading function, and so forth. These predetermined functions can be selected and configured by the user. The function to be restricted may vary, depending on the mobile device.

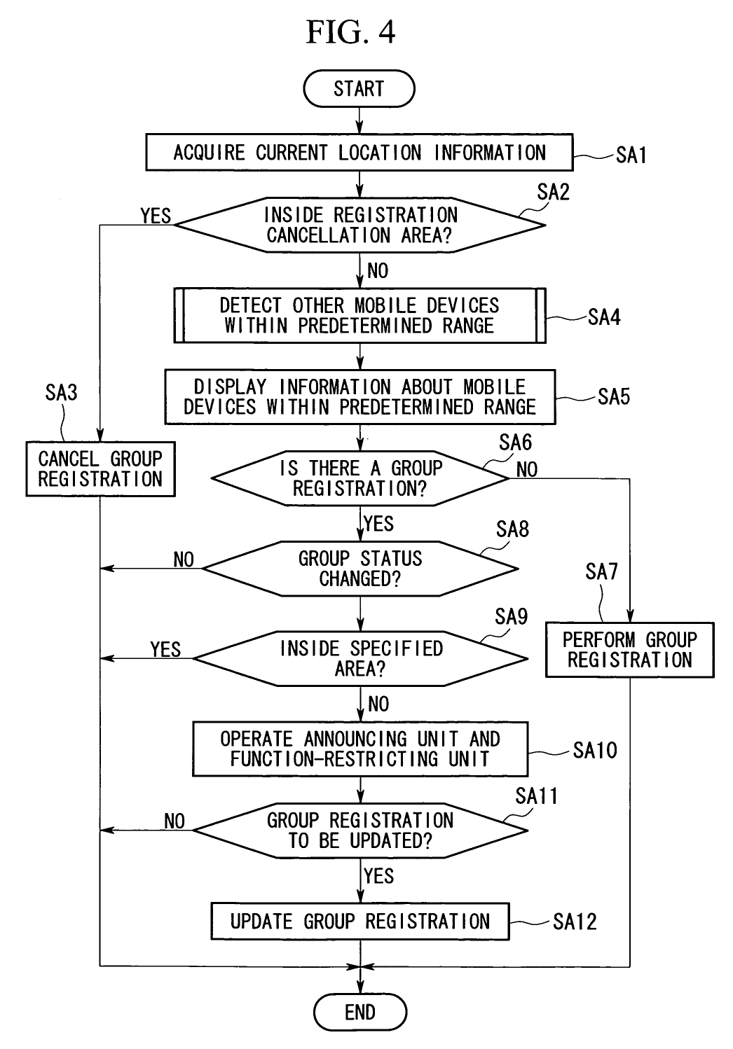

In each of the mobile devices having such a common configuration, a misplacement detection process, as shown in FIG. 4, is repeatedly executed by the control unit 16 at fixed intervals. Although the process described below is executed in the control unit 16 of each mobile device, for simplification, the control unit 16 of the mobile phone 3 will be described here as a representative example.

First, when the location information acquired by the GPS receiver 11 is input (step SA1 in FIG. 4), the control unit 16 of the mobile phone 3 determines whether or not this location information belongs to the registration cancellation area registered in advance in the storage unit 15 (step SA2). If, as a result, it is determined that the current location belongs to the registration cancellation area (“YES” in Step SA2), group registration by the group registration unit 18 is cancelled (step SA3), and the process then ends.

On the other hand, when it is determined in step SA2 that it is not inside the registration cancellation area, the control unit 16 detects the other mobile devices located within the predetermined range of that device by performing a device detection process (Step SA4).

In this device detection process, first, the control unit 16 sends information linking its own identification number “0003” with the location information acquired by the GPS receiver 11 in step SA1 to the other mobile devices using the communication unit 12. Accordingly, the current location information and the identification information of the mobile phone 3 are sent to the portable music player 4, the PDA 5, and the computer 6. On the other hand, by executing the same process in the control units 16 of the portable music player 4, the PDA 5, and the computer 6, the current location information is exchanged between each mobile device, and the communication unit 12 of the mobile phone 3 receives the identification information and current location information of the portable music player 4, the PDA 5, and the computer 6.

Next, the control unit 16 determines whether or not each mobile device is located within the predetermined range of that device on the basis of its own current location information and the received current location information of the portable music player 4, the PDA 5, and the computer 6, to detect the other mobile devices located within the predetermined range. Here, the predetermined range is a range for identifying that the mobile device and the other mobile devices are being carried together; it can be arbitrarily defined according to the design. For example, it can be set to a range of about 3 m to 5 m.

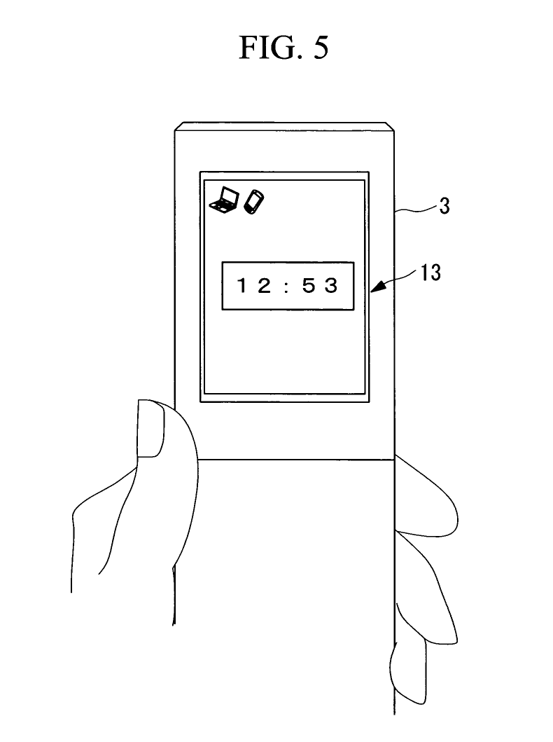

Next, the control unit 16 obtains, from the storage unit 15, icons associated with the identification information of the other mobile devices determined to be located within the predetermined range and displays them on the display unit 13 (step SA5). Accordingly, the icons of the other mobile devices located within the predetermined range of the mobile phone 3 are displayed on the display unit 13. For instance, FIG. 5 illustrates an example of the display unit 13 when the PDA 5 and the computer 6 are determined to be located within the predetermined range.

Next, the control unit 16 determines whether group registration has been performed in the group registration unit 18 (step SA6). If, as a result, group registration has not been performed (“NO” in step SA6), the other mobile devices detected in step SA4 are registered as a group in the group registration unit 18 (step SA7), and the process then ends.

On the other hand, if group registration has been performed in the group registration unit 18 (“YES” in step SA6), it is determined whether the group status has changed (step SA8). More specifically, it is determined whether or not the combination of mobile devices determined to be located within the predetermined range of the mobile phone 3 in the current process, that is, in step SA4 described above, matches the combination of mobile devices registered as a group in the group registration unit 18. If, as a result, they both match (“NO” in step SA8), it is assumed that the group status has not changed, and this process then ends.

On the other hand, if there is an increase or decrease in the combination of mobile devices determined as being located within the predetermined range of the mobile phone 3, that is, if the combination of mobile devices detected in step SA4 differs from the combination of mobile devices registered as a group (“YES” in step SA8), the control unit 16 determines whether or not the mobile device is inside the specified area registered in advance in the storage unit 15 on the basis of the location information acquired by the GPS receiver 11 (step SA9). If, as a result, it is inside the specified area (“YES” in step SA9), the process ends here.

On the other hand, if it is outside the specified area (“NO” in step SA9), the control unit 16 operates the announcing unit 19 and the function-restricting unit 20 (step SA10). Accordingly, it is announced to the user that he or she has forgotten to take a mobile device, and by making it impossible to use a predetermined function of the mobile device, it is possible to prevent another person from using the mobile device.

Next, the control unit 16 queries the user as to whether or not group registration is to be updated (step SA11). This is carried out by, for example, displaying a message “Update group registration?” on the display unit 13 or by providing an audio message. As a result, if there is an input indicating that the group registration is to be updated (“YES” in step SA11), the mobile devices detected in Step SA4 of the present process are registered as a group in the group registration unit 18 (Step SA12), and then the process ends. On the other hand, if there is an input indicating that group registration is not to be updated in Step SA11 (“NO” in step SA1), the process ends without the control unit 16 updating the group registration.

Here, for example, when the user decides to increase the number of mobile devices he or she is carrying or when the user leaves a mobile device behind, then, misplacement etc. must be determined on the basis of the new combination of mobile devices. In addition, if the group registration were not updated, the same announcement would be made the next time the process is executed, and the user would be bothered. Thus, as described above, convenience can be enhanced by allowing the user to determine whether or not to update the group registration.

Then, the control unit 16 repeatedly executes the misplacement detection process shown in FIG. 4 at predetermined intervals to periodically detect misplacement of a mobile device and, when outside the specified area, to announce that fact and restrict the predetermined function.

Next, the misplacement process described above will be explained by giving a concrete example. Similar to the above, the control unit 16 of the mobile phone 3 will be described as a representative example. An example will be described in which an area in the vicinity of the home is registered as the registration-cancellation area, and an area in the vicinity of the workplace is registered as the specified area.

First, when the user is at home and each mobile device is located at home, because he or she is determined as being in the registration cancellation area in step SA2 (“YES” at step SA2), the state in group registration is cancelled is maintained. From this state, when the user takes the mobile phone 3, the portable music player 4, the PDA 5, and the computer 6 and goes outside, in each device, the location information obtained by the GPS receiver 11 is outside of the registration cancellation area (“NO” at step SA2), and the device detection process is executed by the control unit 16 (step SA4). Accordingly, in each mobile device, the other mobile devices located within a predetermined range of that device are detected, and the detected other mobile devices are displayed on the display unit 13 (step SA5). As a result, icons of the other mobile devices that are carried together with that device are displayed on the display unit 13 of each mobile device, and by looking at the display unit 13 of any of the mobile devices, the user can easily check what mobile devices he or she is carrying without checking his or her bag, clothes, etc.

Then, it is determined by the control unit 16 whether or not group registration has been performed in the group registration unit 18 (step SA6). Here, because group registration has not been performed, the control unit 16 registers the other mobile devices detected in step SA4, namely, the portable music player 4, the PDA 5, and the computer 6, as a group in the group registration unit 18, and the process then ends.

Then, by repeatedly executing the forget-to-take detection process described above in the control unit 16 at predetermined intervals, in each mobile device, it is detected whether the mobile devices registered as a group are located within a predetermine range of that device.

In such a case, when the user misplaces the PDA 4 somewhere that is not registered as the specified area, for example, in a train station, in any of the mobile devices, it is determined in step SA8 in FIG. 4 that the group status has changed, in the subsequent step SA9, it is determined that the user is not in the specified area, and in step SA10, the announcing unit 19 and the function-restricting unit 20 are operated. Accordingly, misplacement of a mobile device is announced by any of the mobile devices, and it is possible to prevent the misplaced mobile device from being used by another person by restricting the predetermined function.

When the user is at his or her place of work, which is the specified area, and leaves the portable music player 4, the PDA 5, and the computer 6 on his or her desk and takes only the mobile phone 3, the distance between the mobile phone 3 and the other mobile devices is outside the predetermined range; therefore, although it is determined in step SA8 that the group status has changed, in step SA9, it is detected that the user is in the specified area, and so the process ends there. Accordingly, as described above, the announcing unit 19 and the function-restricting unit 20 are not operated. Thus, the user is not bothered by an announcement and so forth, and can take only the required mobile device and use it.

According to the mobile device system 1 as described above, when leaving the registration cancellation area, the other mobile devices being carried together at that time are detected, and these mobile devices are registered as a group in the group registration unit 18. Therefore, even when the combination of mobile devices that the user carries differs from day to day, the system can respond flexibly at those times.

Outside the specified area, when it is detected that the mobile devices registered as a group are not within the predetermined range of a particular device, the announcing unit 19 and the function-restricting unit 20 of each mobile device are operated. Therefore, it is possible to quickly inform the user of that fact, and it is possible to prevent the misplaced mobile device from being used by someone else.

Furthermore, in a specified area where, among the plurality of mobile devices registered as a group, only some of the mobile devices are temporarily taken out to be used, the announcing unit 19 and the activation-restricting unit 20 are not operated. Therefore, unnecessary announcements and function restrictions can be eliminated in such places. Accordingly, in the workplace, the user can use the mobile devices in the same way as usual.

In this embodiment, the user is informed by displaying the other mobile devices that are located within a predetermined range of a particular device on the display unit 13. Instead of this, however, he or she may be informed audibly. In such a case, an audio output unit for outputting sound, such as a speaker, is provided in addition to the components shown in FIG. 2.

Each mobile device may be configured such that the user can arbitrarily register the registration cancellation area and the specified area by operating the input unit 14. These registrations may be performed, for example, by displaying map information built-into the mobile device on the display unit 13, and the user indicating, on this map, locations that he or she wishes to register as the specified area and the registration cancellation area by operating the input unit 14. If the user is actually at the location he or she wishes to register, the location information acquired by the GPS receiver 11 may be registered as the registration cancellation area or the specified area by operating the input unit 14 at that location.

In this embodiment, it is determined whether or not the device is in the registration cancellation area and whether or not it is in the specified area on the basis of the location information acquired by the GPS receiver 11. Instead of this, however, when the workplace, for instance, is registered as the specified area, the determination may be made on the basis of identification information of a server with which the communication unit 12 establishes communication. In many workplaces, for example, there are many places where company LANs or networks have been set up. Considering this situation, when a predetermined network is detected, that place may be recognized as the workplace. In that case, when, for example, identification information (meta data) of a network server is registered and the identification information of this server is received, it is possible to determine that the device is in the specified area.

### SECOND EMBODIMENT

Next, a mobile device system according to a second embodiment will be described.

In the mobile device system according to the first embodiment described above, the other mobile devices located within the predetermined range are detected on the basis of the location information of each mobile device and the location information of a particular device. In the mobile device system described here, however, the detection of other mobile devices is performed using short-range communication. In the following, components which are the same as the components shown in FIG. 3 are assigned the same reference numerals, and only the differences are described.

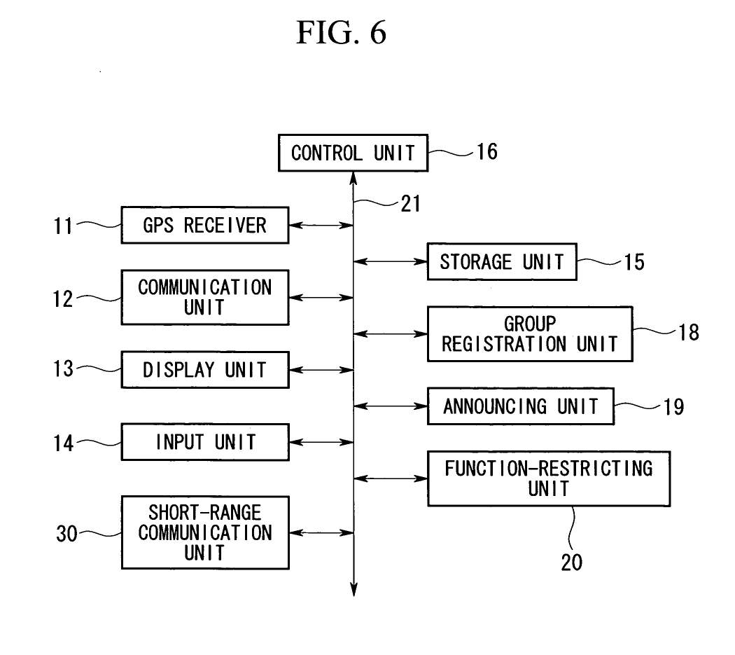

Each mobile device constituting the mobile device system further includes a short-range communication unit 30, as shown in FIG. 6. This short-range communication unit 30 can wirelessly communicate with other mobile devices located in the vicinity. The communication range of this short-range communication unit 30 is preferably a range that allows communication between mobile devices that are carried together, for example, a range of about 1 m to 10 m. A known short-range communication device can be employed as the short-range communication unit 30. For example, it is possible to employ a communication device which performs communication with light, such as infrared light, or a communication device that performs communication using radio waves, such as Bluetooth.

In each mobile device having such a common configuration, in the device detection process performed in step SA4 in FIG. 4, the control unit 16 sends an identification number assigned to that device using the short-range communication unit 30. Accordingly, the identification number of each mobile device is received by the other mobile devices located within the communication range of the short-range communication unit 30. Therefore, in each mobile device located close to each other, it is possible to receive identification information of the other mobile devices. Accordingly, the control unit 16 detects the other mobile devices located in the vicinity based on whether or not the identification information of the other mobile devices is received.

According to this mobile device system, it is possible to detect the other mobile devices located within a predetermined range of a particular device without using location information.

Although embodiments of the mobile device system and the mobile device have been described above with reference to the drawings, the specific configuration is not limited to these embodiments. The present invention encompasses various modifications so long as they do not depart from the spirit of the invention.

What is claimed is:

1. A mobile device system comprising:
a plurality of mobile devices,
wherein each of the mobile devices includes a device detection unit for periodically detecting other mobile devices located within a predetermined range of that device, a group registration unit in which at least one of the other mobile devices is registered as a group, an announcing unit, and a control unit,
when a group status of the other mobile devices detected by the device detection unit differs from a group status registered in the group registration unit, the control unit operates the announcing unit,
each of the mobile devices includes a specified-area detection unit for detecting that the mobile device is inside a specified area, and
when it is detected that the mobile device is in the specified area by the specified-area detection unit, the control unit stops operating the announcing unit.

2. A mobile device system comprising:
a plurality of mobile devices;
wherein each of the mobile devices includes a device detection unit for periodically detecting other mobile devices located within a predetermined range of that device, a group registration unit for registering at least one of the other mobile device as a group, a function-restricting unit for restricting a predetermined function, and a control unit, wherein when a group status of the other mobile devices detected by the device detection unit differs from a group status registered in the group registration unit, the control unit operates the function-restricting unit;
each of the mobile devices includes a specified-area detection unit for detecting whether the mobile device is inside a specified area; and
when it is detected by the specified-area detecting unit that the mobile device is in the specified area, the control unit stops operating the function-restricting unit.

3. A mobile device system according to claim 1, wherein:
each of the mobile devices includes a location-information acquisition unit for acquiring location information; and
when the location information acquired by the location-information acquisition unit belongs to the specified area which is registered in advance, the specified-area detection unit detects that the mobile device is inside the specified area.

4. A mobile device system according to claim 2, wherein:
each of the mobile devices includes a location-information acquisition unit for acquiring location information; and
when the location information acquired by the location-information acquisition unit belongs to the specified area which is registered in advance, the specified-area detection unit detects that the mobile device is inside the specified area.

5. A mobile device system according to claim 1, wherein:
each of the mobile devices includes a communication unit; and
when identification information of a server which communicates with the communication unit matches identification information registered in advance, the specified-area detection unit detects that the mobile device is inside the specified area.

6. A mobile device system according to claim 2, wherein:
each of the mobile devices includes a communication unit; and
when identification information of a server which communicates with the communication unit matches identification information registered in advance, the specified-area detection unit detects that the mobile device is inside the specified area.

7. A mobile device system according to claim 1, wherein each of the mobile devices includes an input unit for a user to register the specified area.

8. A mobile device system according to claim 2, wherein each of the mobile devices includes an input unit for a user to register the specified area.

9. A mobile device system according to claim 1, wherein:
each of the mobile devices includes a registration-cancellation-area detection unit for detecting whether or not the mobile device is in a registration cancellation area; and
when it is detected by the registration-cancellation-area detection unit that the mobile device is in the registration cancellation area, the control unit cancels group registration in the group registration unit, and when it is detected by the registration-cancellation-area detection unit that the mobile device is outside the registration cancellation area, the control unit registers the other mobile devices detected by the device detection unit as a group in the group registration unit.

10. A mobile device system according to claim 2, wherein:
each of the mobile devices includes a registration-cancellation-area detection unit for detecting whether or not the mobile device is in a registration cancellation area; and
when it is detected by the registration-cancellation-area detection unit that the mobile device is in the registration cancellation area, the control unit cancels group registration in the group registration unit, and when it is detected by the registration-cancellation-area detection unit that the mobile device is outside the registration cancellation area, the control unit registers the other mobile devices detected by the device detection unit as a group in the group registration unit.

11. A mobile device system according to claim 1, wherein:
each of the mobile devices includes a location-information acquisition unit for acquiring location information of that device and a communication unit for performing communication with other mobile devices; and
when the location information acquired by the location-information acquisition unit is sent to the other mobile devices using the communication unit and when location information is received from the other mobile devices by the communication unit, the device detection unit detects the other mobile devices that are located within the predetermined range of that device on the basis of that location information and the location information of that device.

12. A mobile device system according to claim 2, wherein:
each of the mobile devices includes a location-information acquisition unit for acquiring location information of that device and a communication unit for performing communication with other mobile devices; and
when the location information acquired by the location-information acquisition unit is sent to the other mobile devices using the communication unit and when location information is received from the other mobile devices by the communication unit, the device detection unit detects the other mobile devices that are located within the predetermined range of that device on the basis of that location information and the location information of that device.

13. A mobile device system according to claim 1, wherein:
each of the mobile devices includes a short-range communication unit for communicating with other mobile devices; and
identification information assigned to that device is sent using the short-range communication unit, and the detection unit detects the other mobile devices that are located within the predetermined range of that device based on whether or not identification information is received from the other mobile devices by the short-range communication unit.

14. A mobile device system according to claim 2, wherein:
each of the mobile devices includes a short-range communication unit for communicating with other mobile devices; and
identification information assigned to that device is sent using the short-range communication unit, and the detection unit detects the other mobile devices that are located within the predetermined range of that device based on whether or not identification information is received from the other mobile devices by the short-range communication unit.

15. A mobile device including a device detection unit for periodically detecting other mobile devices located within a predetermined range of that device, a group registration unit in which at least one of the other mobile devices is registered as a group, an announcing unit, and a control unit, wherein when a group status of the other mobile devices detected by the device detection unit differs from a group status registered in the group registration unit, the control unit operates the announcing unit, wherein the mobile device comprises:
a specified-area detecting unit for detecting that the mobile device is in a specified area;
wherein when it is detected by the specified-area detecting unit that the mobile device is in the specified area, the control unit stops operating the announcing unit.

16. A mobile device including a device detection unit for periodically detecting other mobile devices located within a predetermined range of that device, a group registration unit for registering at least one of the other mobile devices as a group, a function-restricting unit for restricting a predetermined function, and a control unit, wherein when a group status of the other mobile devices detected by the device detection unit differs from a group status registered in the group registration unit, the control unit operates the function-restricting unit, wherein the mobile device comprises:
a specified-area detecting unit for detecting that the mobile device is in a specified area;
wherein when it is detected by the specified-area detecting unit that the mobile device is in the specified area, the control unit stops operating the function-restricting unit.
